(19) United States
(12) Patent Application Publication
(10) Pub. No.: US 2006/0252539 A1
(43) Pub. Date: Nov. 9, 2006

(54) Game software's direction control device and method for handheld apparatus

(75) Inventors: Zheng Zhang, Taipei (TW); David Ho, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Appliances Corporation, Taipei (TW)

(21) Appl. No.: 11/187,527

(22) Filed: Jul. 22, 2005

(30) Foreign Application Priority Data
Dec. 17, 2004 (TW) 093139298

(51) Int. Cl. A63F 13/00

(52) U.S. Cl. 463/36

(57) ABSTRACT

A direction control device and method for game software on handheld electronic devices is provided. The main structure comprises a displacement vector detection module, a central process module and a storage module. With an acceleration sensor of the displacement vectors detection module to detect the apparatus' direction moving vector and an analogical/digital data converter to convert the vector to digital vector data, comparing with the data from the storage module and determining the direction moving information based on the comparison result, it outputs the direction information to the game software to improve the difficult control defect caused by control keys miniaturized to smaller and smaller of handheld electronic apparatus nowadays

### BACKGROUND OF THE INVENTION

1. Field of the Invention

The invention generally relates to a direction control device and method for handheld electronic apparatus' game software, especially to the assistance of the direction control function for a game in handheld electronics apparatus (i.e. mobile phones and personal digital assistances (PDA)).

2. Description of Related Art

With more popular and more sophisticated of the handheld electronic apparatus and under the trend of more functioning of the multimedia features, the handheld electronic apparatus added powerful function games has become an indispensable essential feature. And because of the miniaturization of the handheld electronic apparatus, most of the apparatus' control keys are also getting more miniaturized that they can't meet the need of the requests of high audio/video effect, high speed and high excitement of the game control.

Furthermore, as mentioned above, conventional techniques of the direction control can only suit for two-dimensional plane control, but for the control of aviation or as the same of three-dimensional game software, it seems beyond their control.

### SUMMARY OF THE INVENTION

The invention is to use the published indexical target tracing techniques such as: Taiwan patent No. 594553. This patented technique is a displacement vector detection technique that can obtain an indexical target from the moving vector of X, Y and Z axles in space. The technique can link up with an analogical/digital converter module, which is mostly used for handwriting inputting, to make a new and omni-direction control system that fits well with three-dimensional games.

The object of the invention is to provide a direction control device for game software in handheld electronic apparatus. The direction control device comprises a displacement vectors detection module, a central process module, and a storage module. With the acceleration sensor and the analogical/digital data converter in the displacement vector detection module recording a moving vector of the direction control device in a space and converting it to a digital vector data, after checking and comparing the digital vector data with the built-in digital vector data on the storage module, the central process module can determine the moving direction and outputs a direction signal; and the storage module includes a built-in digital vector data and a relation database of at least twenty-four direction datum for checking and comparing by the central process module so as to procure controlling of game in the direction.

The invention also provides a method for the above apparatus, comprising:
moving a direction control device to a direction in a space and recording its moving vector;
converting the moving vector to a digital vector data;
checking and comparing the digital vector data with a built-in digital vector data on the storage module;
determining a direction based on the comparison result; and
outputting a direction signal based on the direction.

Comparing with conventional game control device, the invention creates a game control reality of another different touch without the need of pressing several keys for a move.

### BRIEF DESCRIPTION OF THE DRAWINGS

FIG. 1 is a system structural view of the direction control device of handheld electronic apparatus' game software of the invention;

FIG. 2 is a descriptive view of three-dimensional plane;

FIG. 3 is a descriptive view of direction classification of one plane; and

FIG. 4 is a flow chart of the major operations of a direction control device of handheld electronic apparatus' game software of the invention.

### DESCRIPTION OF THE PREFERRED EMBODIMENT

Referring to the drawings, the preferred embodiment of the invention is fully detailed with the description given herein below.

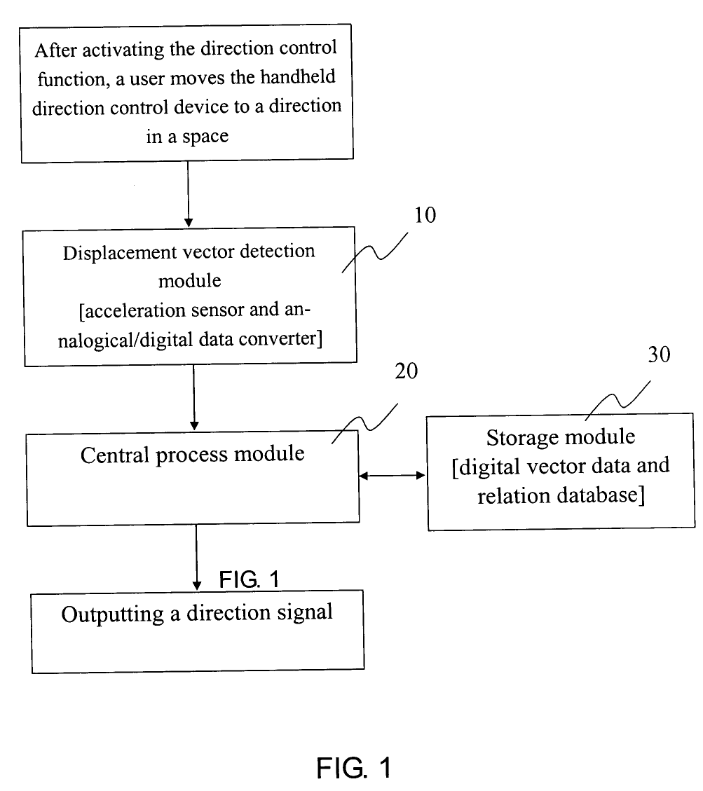

FIG. 1 is a system structural view of the direction control device of the invention for handheld electronic apparatus' game software. The direction control device is mainly applicable to handheld electronic apparatus to control directions, when it processes the game software on the devices. The direction control device comprises:

A displacement vector detection module 10 includes an acceleration sensor 101 and an analogical/digital data converter module 102. The acceleration sensor 101 is used to detect and record the moving vector of the direction control device in a space. And with the analogical/digital data converter 102, the moving vector is converted into digital vector data.

A central process module 20 checks and compares the digital vector data with the built-in digital vector data on a storage module 30 to determine the real moving direction, and outputs a signal of the real moving direction to the game software to complete the input procedure of the direction control; and

A storage module 30 includes a built-in digital vector data and a relation database of twenty-four direction datum for referring of the central process module 20.

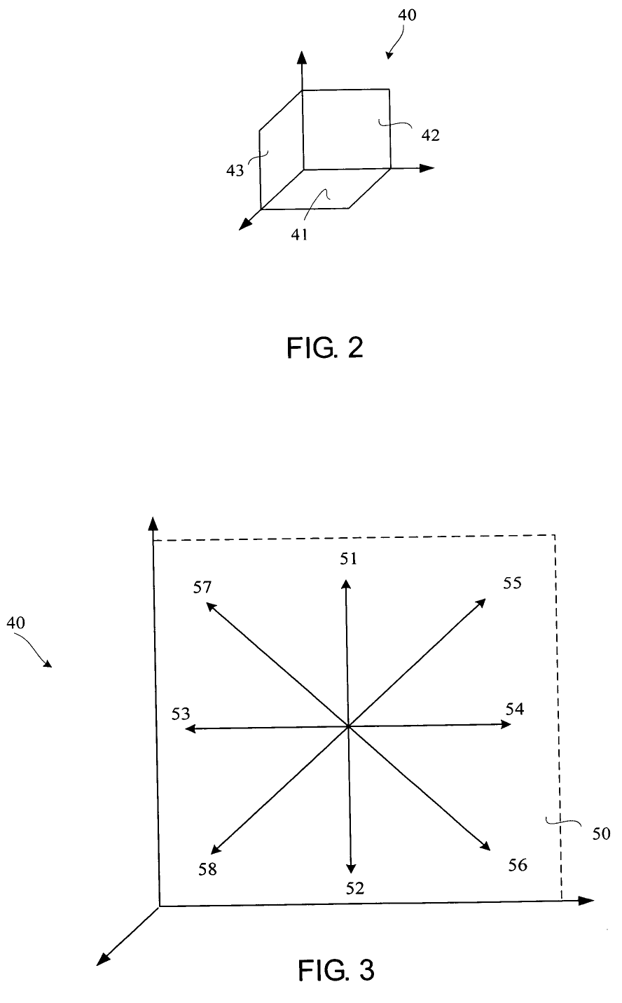

The twenty-four directions of the storage module 30 is related to a three-dimensional plane 40 which includes X plane 41, Y plane 42, and Z plane 43. And each plane 50 has directions of up 52, down 52, left 53, right 54, upper right 55, lower right 56, upper left 57 and lower left 58 that makes total twenty-four direction datum, as shown in FIGS. 2 and 3.

However, the function of the analogical/digital data converter 102 can be shifted from the displacement vectors detection module 10 to the central process 20 is also included within the scope of this invention's system structure.

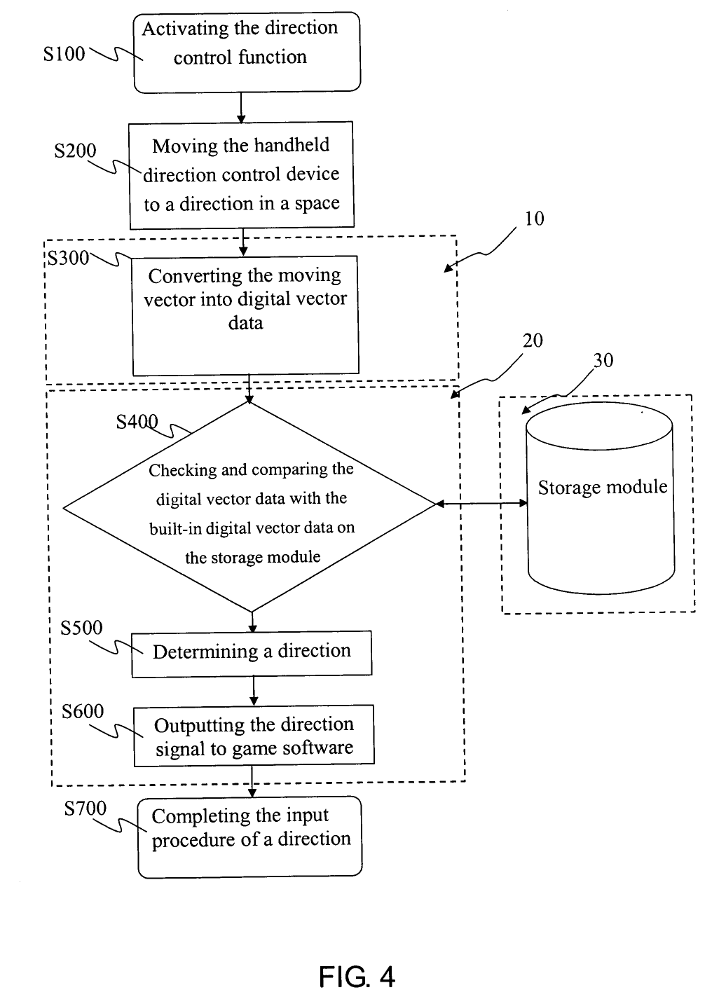

As shown in FIG. 4, according to the above formation of each structure, the direction control method comprises the following steps:

At first, when a user is going to play a game, the user can decide not to activate the function provided by this invention and use the specific direction keys and function keys as conventional method to control directions. Also, the user can also decide to activate the function provide by the invention to work together with the function keys (not direction keys). After activating the direction control function (S100), the user moves the handheld direction control device that comprises a displacement vectors detection module 10 to a direction in a space. And the acceleration sensor 101 detects and records the moving vector (S200), the analogical/digital data converter 102 converts the moving vector into digital vector data (S300), and then the central process module 20 checks and compares the digital vector data with both the built-in digital vector data and the relation database of direction datum of the storage module 30 (S400). According to the comparison result, the central process module 20 can determine a direction (S500), and output the direction signal to game software (S600) to complete the input procedure of a direction (S700).

For example, when a user activates the function provided by the invention and moves the handheld apparatus to the left during the game, the displacement vectors detection module 10 records and samples the moving vector and converts it to digital vector data. After the central process module 20 checks and compares the digital vector data with the twenty-four direction datum of the storage module 30 and obtains that the movement direction is a left direction, it delivers a signal of moving left to the game to complete the direction control function of left movement in the game.

The direction control method for game software employs the displacement vectors detection module 10 to record direction vectors and control the directions that makes users more directly control directions and avoid an inconvenience of pressing the miniaturized direction keys and poor controlling for three-dimensional control.

The invention becomes fully understood from the detailed description given herein above that the same already conforms to the conditions of patent applications and really provides a new functional structure combination for the game direction control device of handheld electronic apparatus to allow users, with a novel movement, to input omni-direction movement directions of up, down, left, and right. The invention being thus described, it will be obvious that the same may be varied in many ways. Such variations are not to be regarded as a departure from the spirit and scope of the invention, and all such modifications as would be obvious to one skilled in the art are intended to be included within the scope of the claims.

What is claimed is:

1. A direction control device for handheld electronic apparatus' game software applicable to the direction control comprises:
a displacement vector detection module including an acceleration sensor and an analogical/digital data converter, wherein said acceleration sensor is used to detect and record a moving vector of said direction control device in a space, and said analogical/digital data converter is used to convert said moving vector into a digital vector data;
a storage module including a built-in digital vector data and a relation database of at least twenty-four direction datum; and
a central process module, wherein said central process module compares said digital vector data with said built-in digital vector data from said storage module to determine a moving direction and outputs a direction signal of the moving direction.

2. A direction control device according to claim 1, wherein said analogical/digital data converter can move to said central process module from said displacement vectors module.

3. A direction control device according to claim 1, wherein said at least twenty-four direction datum of said storage module is of three-dimensional plane of plane X, plane Y and plane Z, with each plane having directions of up, down, left, right, upper right, lower right, upper left and lower left, that makes total twenty-four directions.

4. A direction control device according to claim 1, wherein said handheld electronic apparatus is a mobile phone.

5. A direction control device according to claim 1, wherein said handheld electronic device is a personal digital assistance (PDA).

6. A direction control method for handheld electronic apparatus' game software applicable to handheld electronic apparatus to control direction, comprising the steps of:
moving a direction control device to a direction in a space and recording its moving vector;
converting said moving vector to a digital vector data;
checking and comparing said digital vector data with a build-in digital vector data;
determining a direction based on the comparison result; and
outputting a direction signal based on said direct.

7. A direction control method according to claim 6, wherein said handheld electronic apparatus is a mobile phone.

8. A direction control method according to claim 6, wherein said handheld electronic apparatus is a personal digital assistance (PDA).
